(19) United States
(12) Patent Application Publication
(10) Pub. No.: US 2026/0131365 A1
(43) Pub. Date: May 14, 2026

(54) RECYCLABLES PROCESSING SYSTEM AND METHOD

(71) Applicant: Blue Vision Machine LLC, Franklin, TN (US)

(72) Inventors: Randall James, Franklin, TN (US); Tommy Stott Massey, Franklin, TN (US)

(21) Appl. No.: 19/386,694

(22) Filed: Nov. 12, 2025

Related U.S. Application Data
(60) Provisional application No. 63/719,931, filed on Nov. 13, 2024.

(51) Int. Cl. B09B 3/32; B09B 3/35; B09B 101/75

(52) U.S. Cl. CPC B09B 3/32; B09B 3/35; B09B 2101/75

(57) ABSTRACT

A system and method for processing recyclable plastic containers includes providing a recyclables densification apparatus at a decentralized collection location. This location can be a public-access site, such as a transfer station or neighborhood facility, separate from a centralized material recovery facility. The apparatus includes an infeed hopper for receiving containers, a rotary processing assembly, a fixed plate with at least one opening, and an exit opening. The rotary processing assembly includes at least one rotating shaft with processing elements. The method continues by receiving the containers in the hopper and actuating the assembly. This processing pierces and compacts the containers, expelling air as the processing elements rotate and interact with the fixed plate. The pierced and compacted containers are forced through the exit opening and into a movable collection container below. This produces a densified bulk material at the collection site, enabling efficient transport.

### PRIORITY CLAIM

This application claims the priority filing benefit of U.S. Provisional Patent Application No. 63/719,931 filed November 13, 2024 for “Recyclables Compaction Equipment” of Randall James and Tommy Scott Massey, hereby incorporated by reference in its entirety as though fully set forth herein.

### BACKGROUND

Waste management systems often utilize transfer stations to consolidate waste and recyclables for efficient handling and transport. Recyclable materials, gathered from collection points, such as convenience centers and residential curbside programs, require transport to material recovery facilities (MRFs) for subsequent sorting and handling. A significant operational challenge in this logistical chain is the high cost associated with transporting these recyclable materials from the collection points or transfer stations to the distant MRFs. These transportation expenses represent a substantial financial burden on municipal budgets and private waste management operations.

The challenge of high transport costs is particularly pronounced when handling bulky, low-density materials. Plastic containers, bottles, and jugs, for example, occupy significant volume relative to their weight. Conventional compaction equipment is frequently used in an attempt to reduce the volume of these materials before transport. However, existing compaction methods often fail to effectively process items, such as plastic containers, that trap air or contain residual liquids. These containers resist full compaction, leading to inefficiently packed, low-density bales or loads. This inefficiency results in transport vehicles carrying significantly less material by weight than their volume capacity might otherwise enable. Consequently, the failure of current equipment to adequately densify these materials results in more trips, higher fuel consumption, and diminished economic viability for recycling programs.

Sustainable storage and transportation of recyclable materials often necessitates a dedicated densification process to remove trapped air, expel residual liquids, and reduce overall volume. While various densification machines exist to perform this function, they present significant disadvantages for many operators. Such equipment commonly requires a substantial capital investment, occupies a large operational footprint within a facility, and consumes considerable amounts of energy during operation. These factors can render existing densification solutions impractical for many facilities. Furthermore, alternative volume reduction methods, such as shredding, are generally unsuitable due to the mess they make and the inability to bale the shredded material for bulk transport.

### BRIEF DESCRIPTION OF THE DRAWINGS

FIG. 1is an illustration showing an example recyclables processing system and method as it may be implemented at a waste transfer station or neighborhood recycling facility.

FIG. 2 is a diagram illustrating some differences between the example recyclables processing system and method disclosed herein and conventional waste and recyclables handling.

FIG. 3 is a high-level illustration of the example recyclables processing system and method.

FIGS. 4-7 are various isometric views of an example apparatus for implementing the example recyclables processing system and method.

FIGS. 8-11 are various side views of the example apparatus depicted in FIGS. 4-7.

FIGS. 12-15 are close-up isometric views showing an example infeed hopper assembly of the example apparatus depicted in FIGS. 4-7.

FIGS. 16-17 are close-up isometric views showing an example rotary shredding assembly of the apparatus depicted in FIGS. 4-7.

FIG. 18 is an isometric view of an attachable gripping member which can be implemented with the example recyclables processing system and method.

FIGS. 19-20 are isometric views showing the attachable gripping member depicted in FIG. 18 as it may be implemented with a bulk material handling cart of the example recyclables processing system and method.

### DETAILED DESCRIPTION

The example recyclables processing system and method disclosed herein provide significant improvements to the processing and handling of recyclable materials. The example recyclables processing system and method includes an apparatus for recyclables shredding and hence densification, which enables a substantial reduction in the required operational footprint for processing activities. For example, facilities that previously required 50,000 square feet for material recovery operations may be replaced by the apparatus disclosed herein occupying only 2,000 square feet. This reduction in physical size enables the processing of materials at new, dispersed locations, such as local transfer stations or neighborhood recycling centers (e.g., grocery stores, apartments or condominium complexes, etc.), which were previously unsuitable for such activities. Furthermore, the example apparatus reduces or altogether eliminates the high noise levels associated with conventional compactors and sorting lines. It also mitigates the need for expensive, large-scale sortation machines and the large personnel crews required to operate them.

The example recyclables processing system and method also enables improvements in collection and transportation logistics. By effectively densifying materials, the example recyclables processing system and method reduces the dependency on large roll-off trucks, which are commonly used to transport lightweight, high-volume recyclables. This reduction in truck traffic consequently lowers fuel consumption and the associated vehicle emissions. The improved efficiency and smaller operational footprint created by the example recyclables processing system and method may also enable new access to recycling programs for previously underserved populations, such as residents of multi-family dwellings, rural areas, and small businesses.

Adoption of the example recyclables processing system and method promotes higher overall recycling rates. An increase in the volume of materials successfully recovered and reprocessed corresponds to an increase in available landfill space, extending the operational life of disposal sites. The improved process also provides benefits to commodities markets. By increasing the available supply of recycled source material, the example recyclables processing system and method may contribute to stabilization or reduction in raw material prices, helping to offset inflationary pressures on virgin materials.

In an example, the recyclables processing system and method include a shredding apparatus. An example apparatus includes an infeed hopper. This hopper is configured to receive recyclable materials, which may be fed as individual plastic containers or in larger quantities, such as bucketloads. A rotating shaft, to which stiff tines, bars, and/or blades are mounted, is positioned above the bottom of the hopper. The shaft rotates the tines, which compels the material through a plurality of fixed openings or slots at the bottom of the hopper. This action results in the shredding, piercing, and/or crushing of the material.

The processed or shredded material, having been reduced in volume, then drops into a bulk material handling cart situated under the hopper. Operators can wheel this cart away from the apparatus to transfer the material to a transport truck or to load it into a larger bin for storage prior to transport from the facility. The example apparatus also provides a method for clearing the tines. Any materials that may get wrapped around the stiff tines during the crushing process are removed as the rotating bars are forced through a separate return opening in the hopper.

An example process for reducing the volume of recyclable plastic containers is also disclosed. This process includes loading the recyclable plastic containers into a hopper. A shaft extending at least partly through the hopper rotates about its central axis. This rotation moves tines, blades, or gears through a plurality of slots located in the hopper, enabling the tines, blades, or gears to contact the recyclable plastic containers. The process further includes the piercing and compacting of the plastic containers as the tines or blades continue to rotate and make contact with the material. Following this action, the pierced and compacted recyclable plastic containers are released from the hopper through an exit opening. The material then enters a collection container positioned for receipt beneath the hopper.

The example recyclables processing system and method described herein address the identified deficiencies of existing solutions. The example apparatus is simple to manufacture, install, and maintain. It consumes very little energy during operation, directly contrasting with the high energy consumption of conventional densification machines. The example apparatus is also quiet and inexpensive to acquire and operate. These characteristics make the example apparatus suitable for deployment at locations that are sensitive to noise, smell, or dust, such as near businesses or residential neighborhoods where transfer stations are commonly located. By providing an economical and low-impact solution, the example apparatus enables efficient densification at a wider range of facilities, including those previously constrained by the cost, footprint, or energy requirements of prior art systems.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

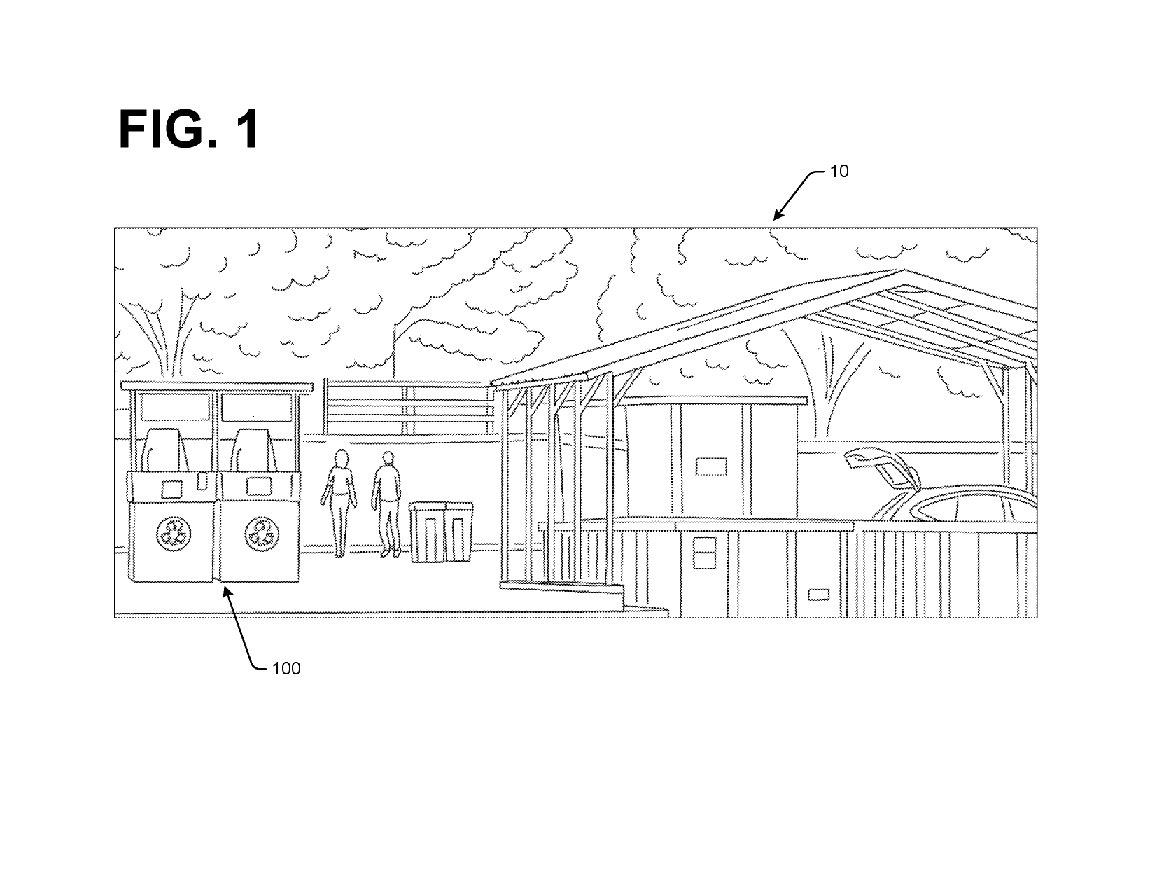

FIG. 1 is an illustration showing an example recyclables processing system and method as it may be implemented at a variety of locations 10. These locations can include a waste transfer station or a neighborhood recycling facility. Other possible settings include a grocery store, an apartment complex, condominiums, or other local areas where operators do not typically install conventional waste processing equipment.

This wide range of potential deployment locations highlights how the example present invention addresses the shortcomings of the prior art. Conventional recycling and processing equipment is often large, expensive, noisy, and consumes significant energy. These factors restrict its use to large, centralized, and properly zoned facilities, such as distant material recovery facilities (MRFs). The example apparatus 100, by contrast, is configured to be compact, quiet, and economical, which enables its installation in these new, decentralized locations.

Placing the apparatus 100 of the example recyclables processing system and method at or near the initial point of collection, such as in an apartment complex or retail center, enables immediate volume reduction. This local densification directly confronts the problem of high transportation costs by ensuring that materials are already compacted before requiring transport to a central processor, thereby reducing the truck traffic, fuel consumption, and operational expenses associated with hauling bulky, low-density materials.

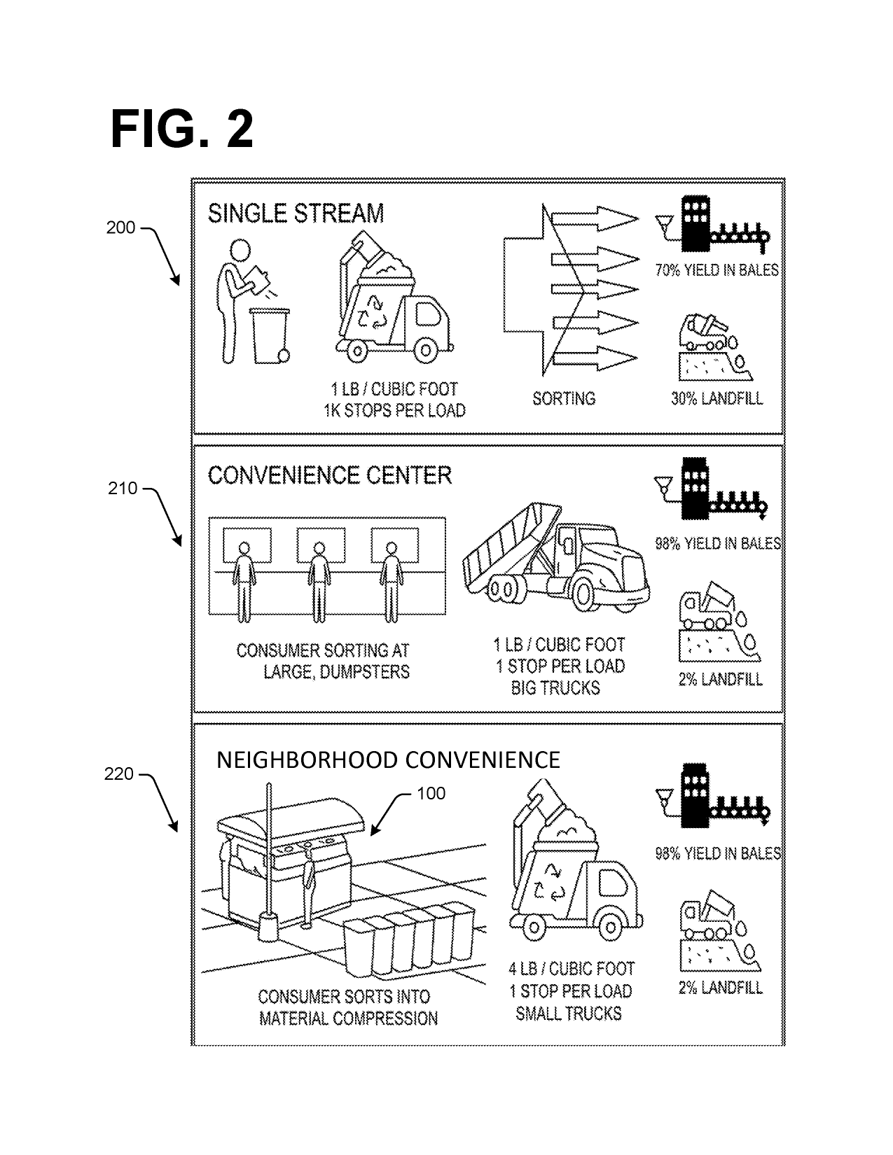

FIG. 2 is a diagram illustrating some differences between the example recyclables processing system and method disclosed herein and conventional waste and recyclables handling. The diagram compares three distinct workflows, identified as "SINGLE STREAM" workflow 200, "CONVENIENCE CENTER" workflow 210, and "NEIGHBORHOOD CONVENIENCE" workflow 220.

The "SINGLE STREAM" workflow 200 illustrates a conventional curbside collection process. A collection truck makes numerous stops, such as 1,000 stops per load, to gather mixed recyclables. This commingled material has a low density, indicated as approximately one pound per cubic foot. The commingled material must then undergo an extensive sorting process at a recovery facility. This workflow is inefficient, resulting in approximately 70 percent of the material being recovered in bales while 30 percent is still sent to a landfill.

The "CONVENIENCE CENTER" workflow 210 depicts another common method where consumers transport and pre-sort their recyclables into large, separate dumpsters at a centralized drop-off location. A large truck collects the material from this single stop. While the consumer sorting in this scenario leads to a high recovery rate, shown as 98 percent yield in bales, the material density remains low at approximately one pound per cubic foot. This necessitates the use of large trucks for transporting an inefficient, relatively low weight by volume container.

The "NEIGHBORHOOD CONVENIENCE" workflow 220 illustrates the example process implementing the disclosed example recyclables processing system and method. In this process, the consumer sorts material directly into the apparatus 100 disclosed herein at a local convenience site, which as noted above can include nontraditional locations such as a grocery store or other neighborhood dropoff site. The on-site densification using the apparatus disclosed herein creates a material density of approximately four pounds per cubic foot. This four-fold increase in density enables smaller trucks to transport the material from a single stop. The example example recyclables processing system and method maintains a high 98 percent yield (e.g., similar to that observed for bales) and a low, two percent landfill rate, while simultaneously addressing the transport inefficiency of the other methods.

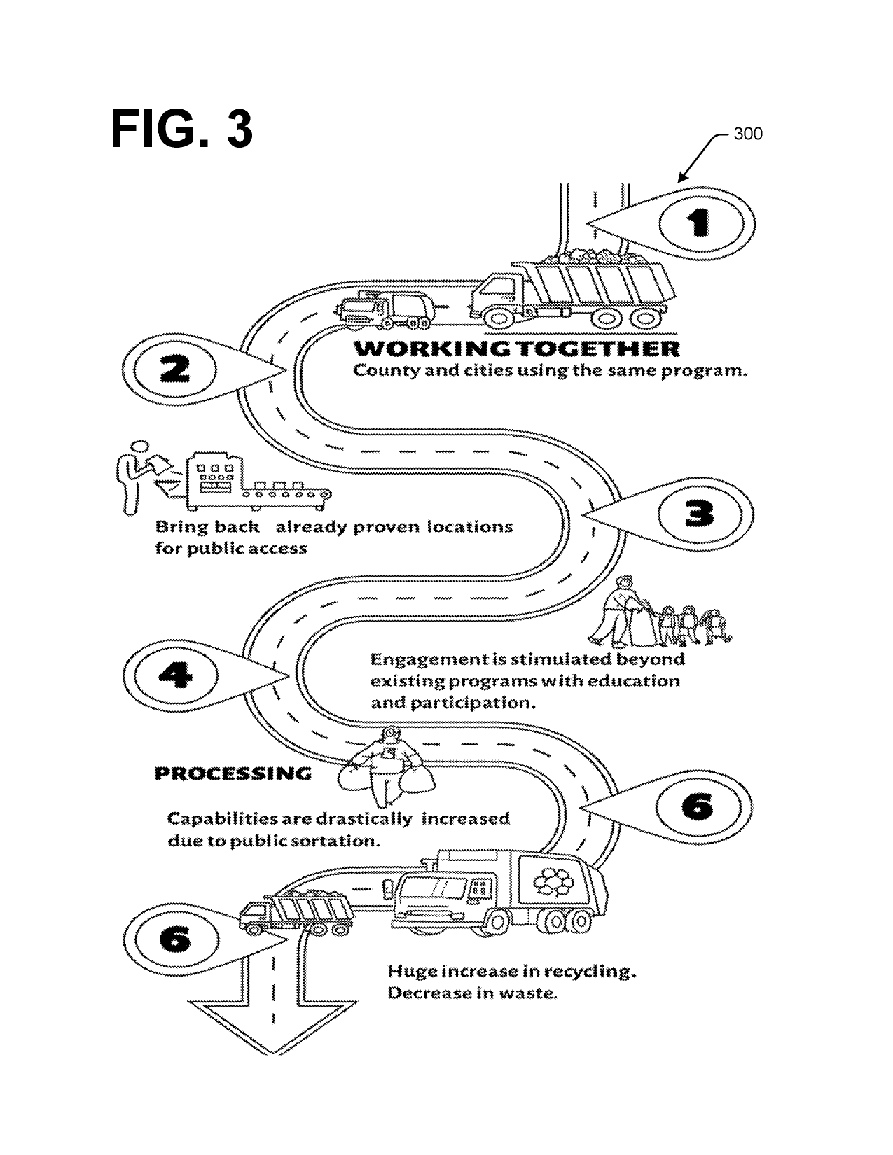

FIG. 3 is a high-level illustration 300 of the example recyclables processing system and method. The example recyclables processing system and method improvement includes lowering the overall expense associated with material collection and processing via shredding and densification. This reduction in cost enables different municipal entities, such as counties and cities, to work together using the same program.

A process improvement includes re-establishing proven, convenient locations for public access to recycling. Another process improvement includes improved accessibility and the associated educational efforts stimulate community engagement and participation beyond existing programs.

Another process improvement includes increasing processing capabilities, supported in part by the users or public performing the initial sortation of materials. The process improvements result in a significant increase in the volume of materials recycled and a corresponding decrease in the amount of waste requiring final disposal.

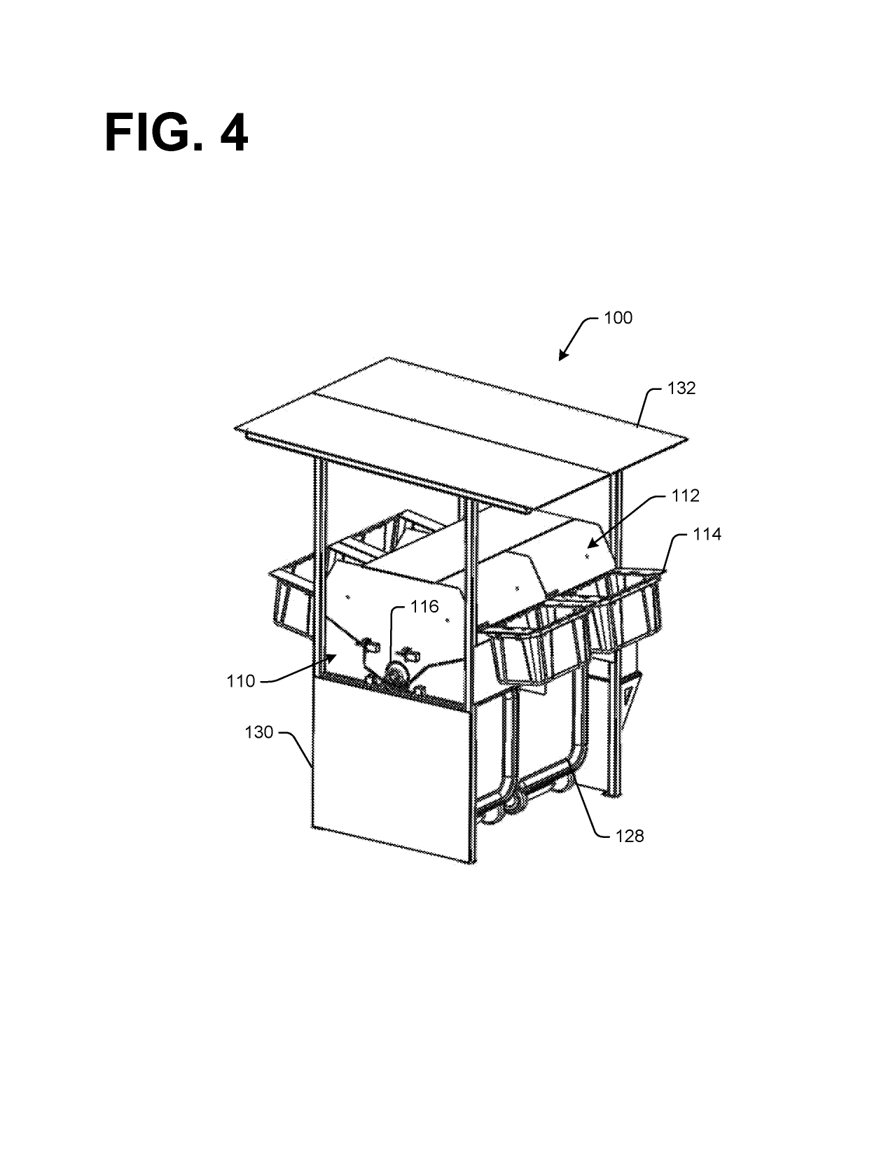

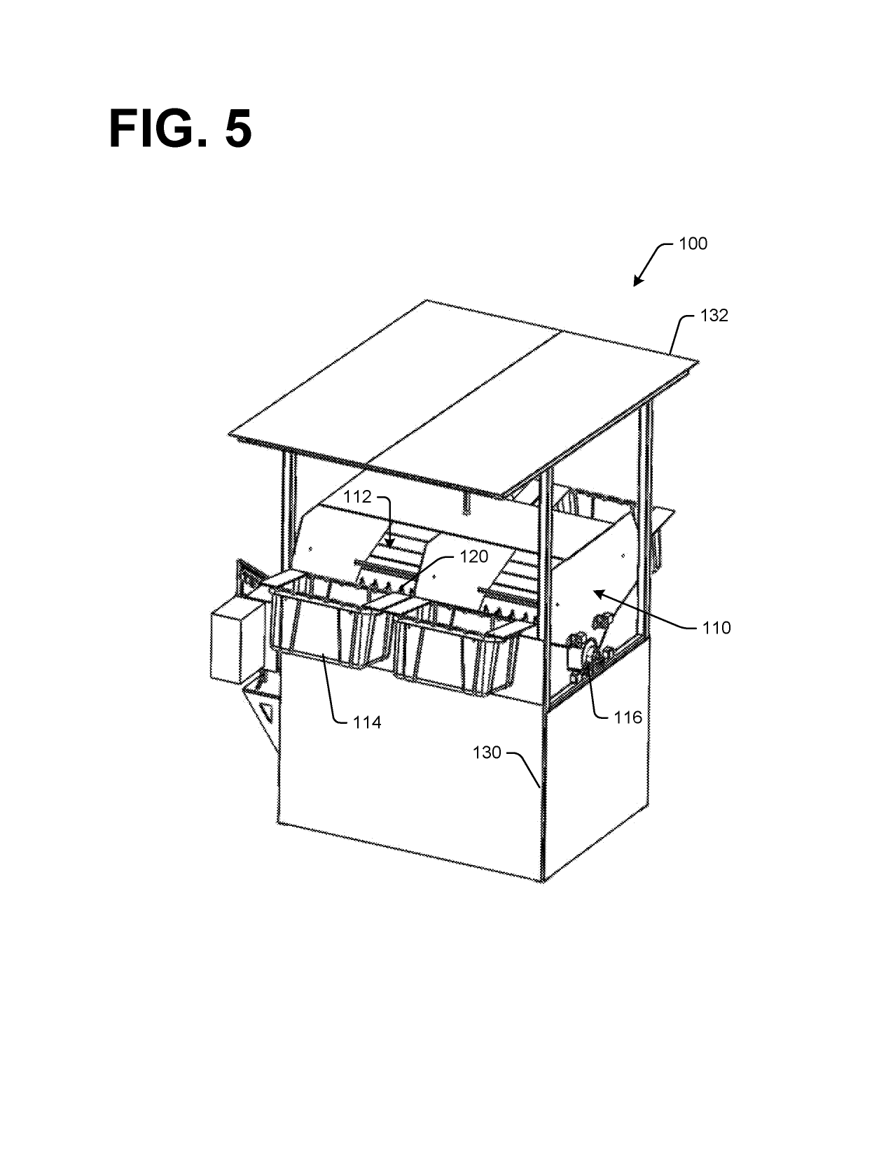

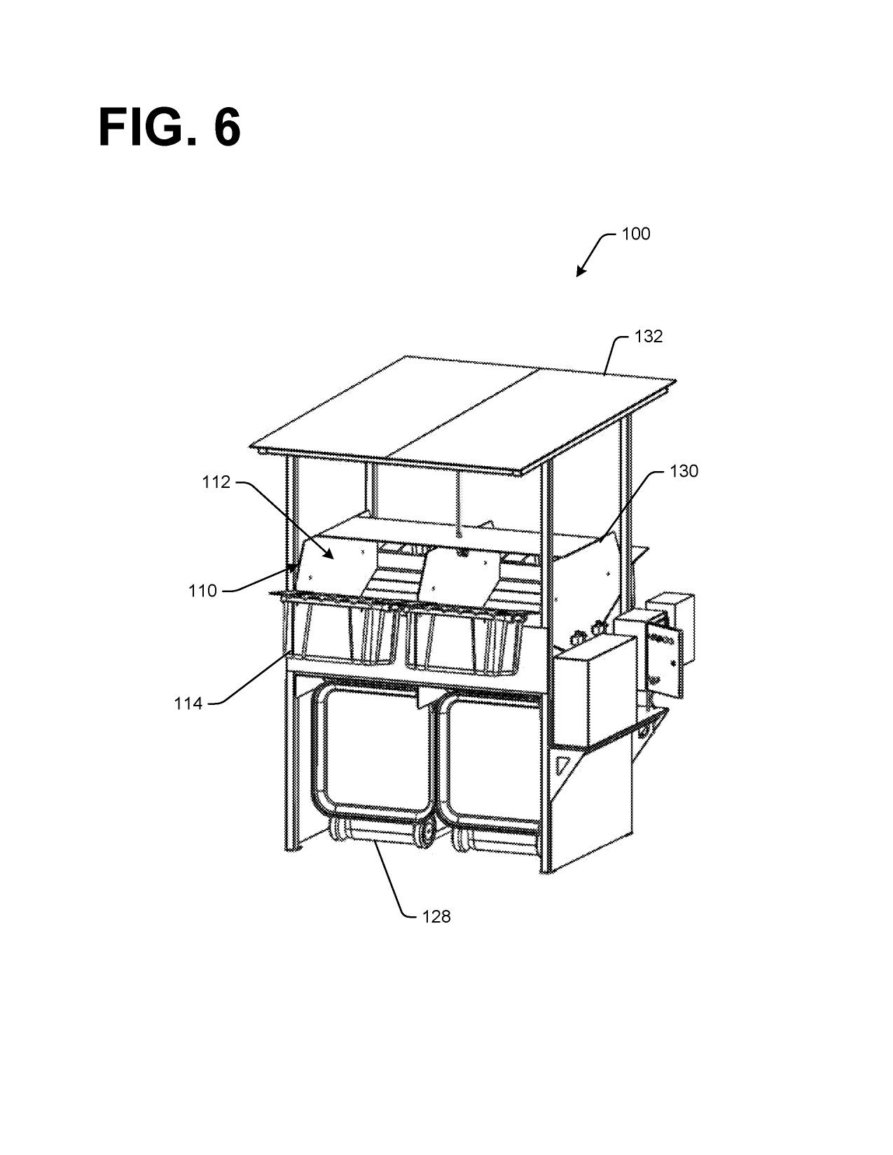

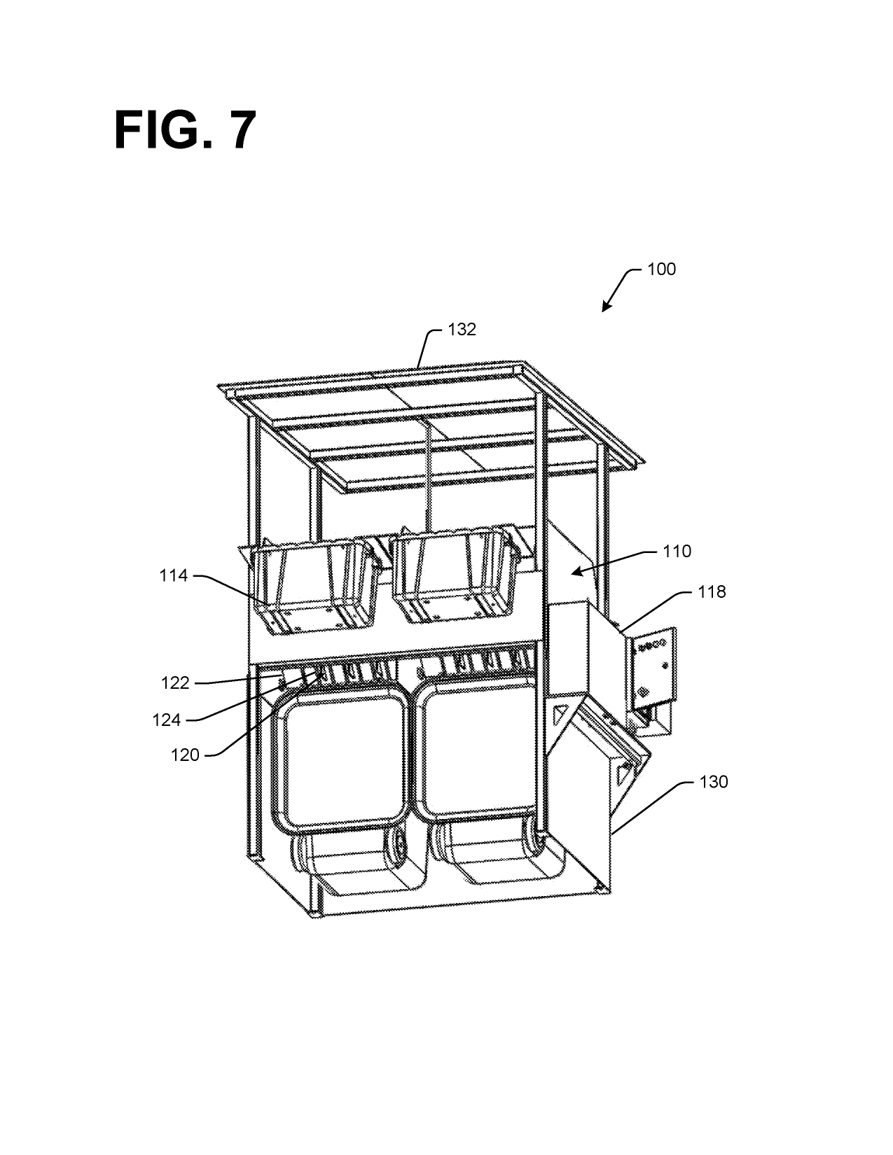

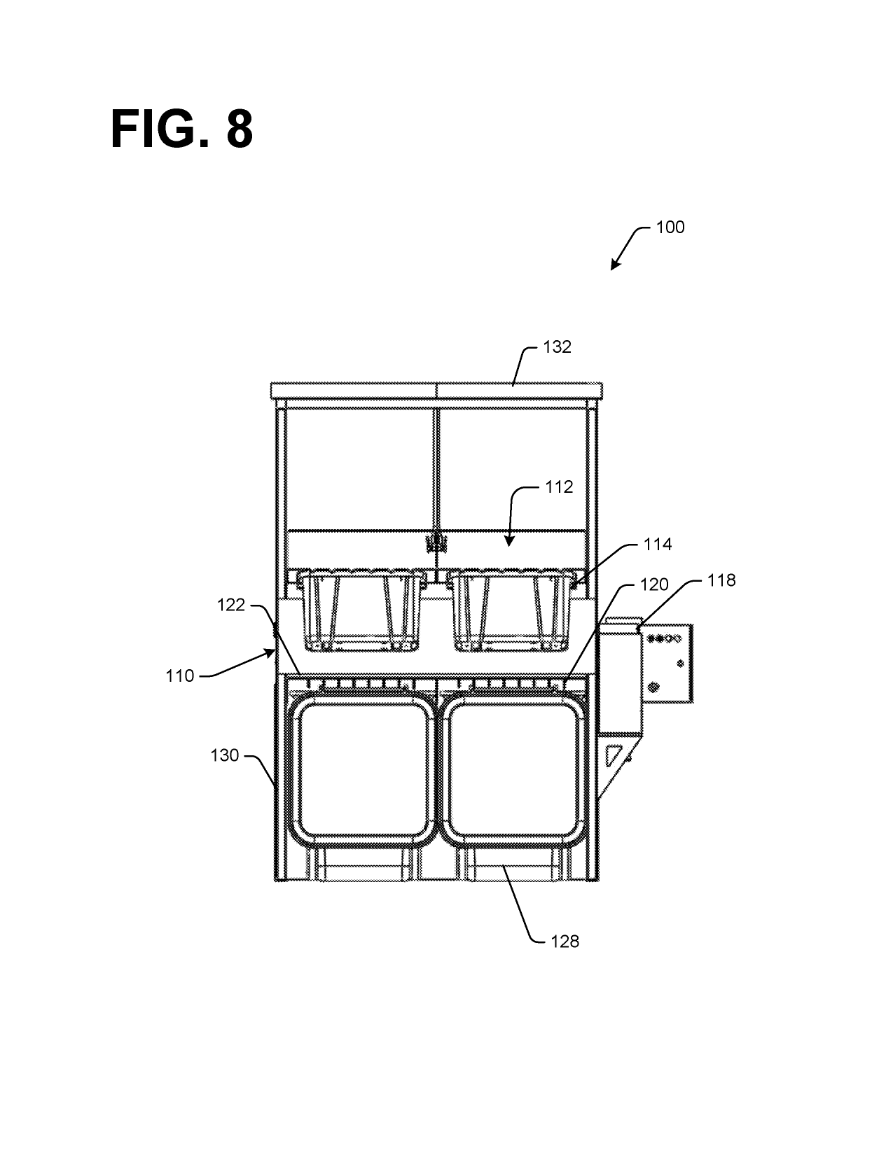

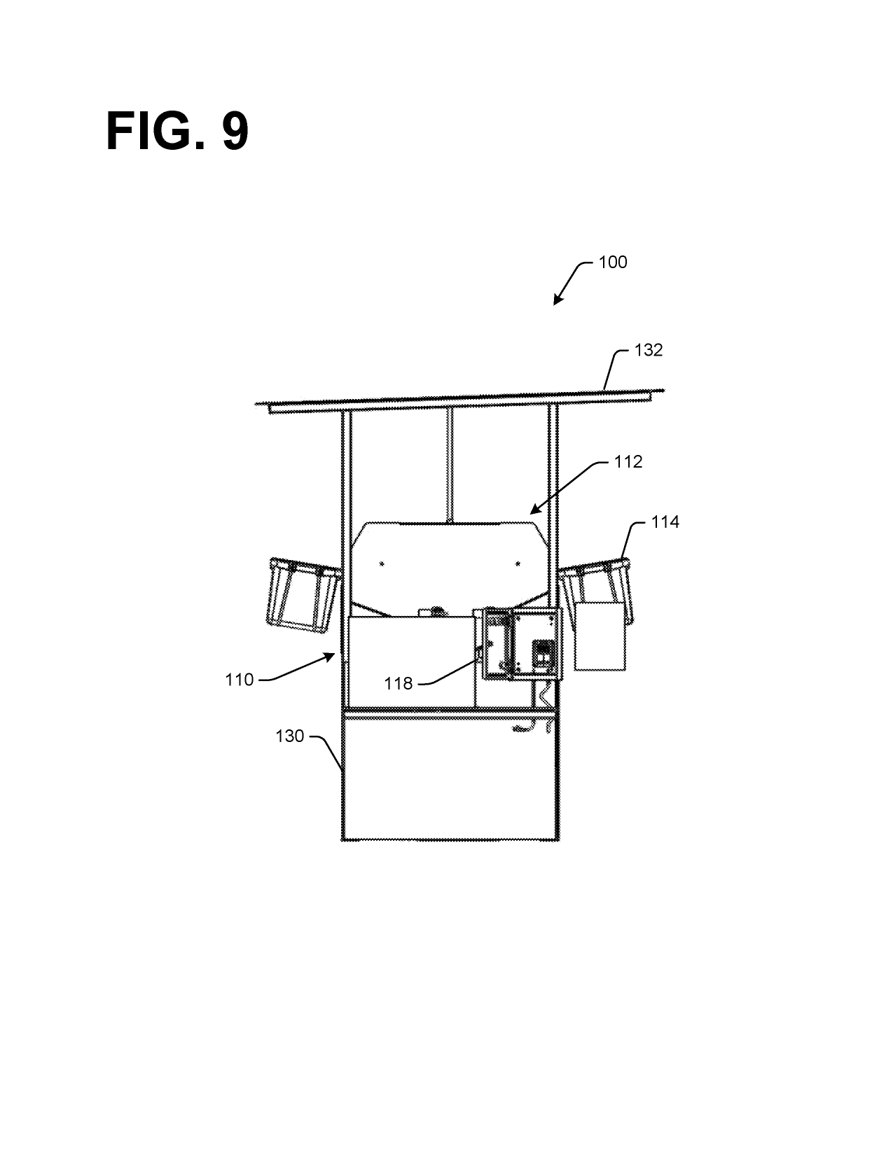

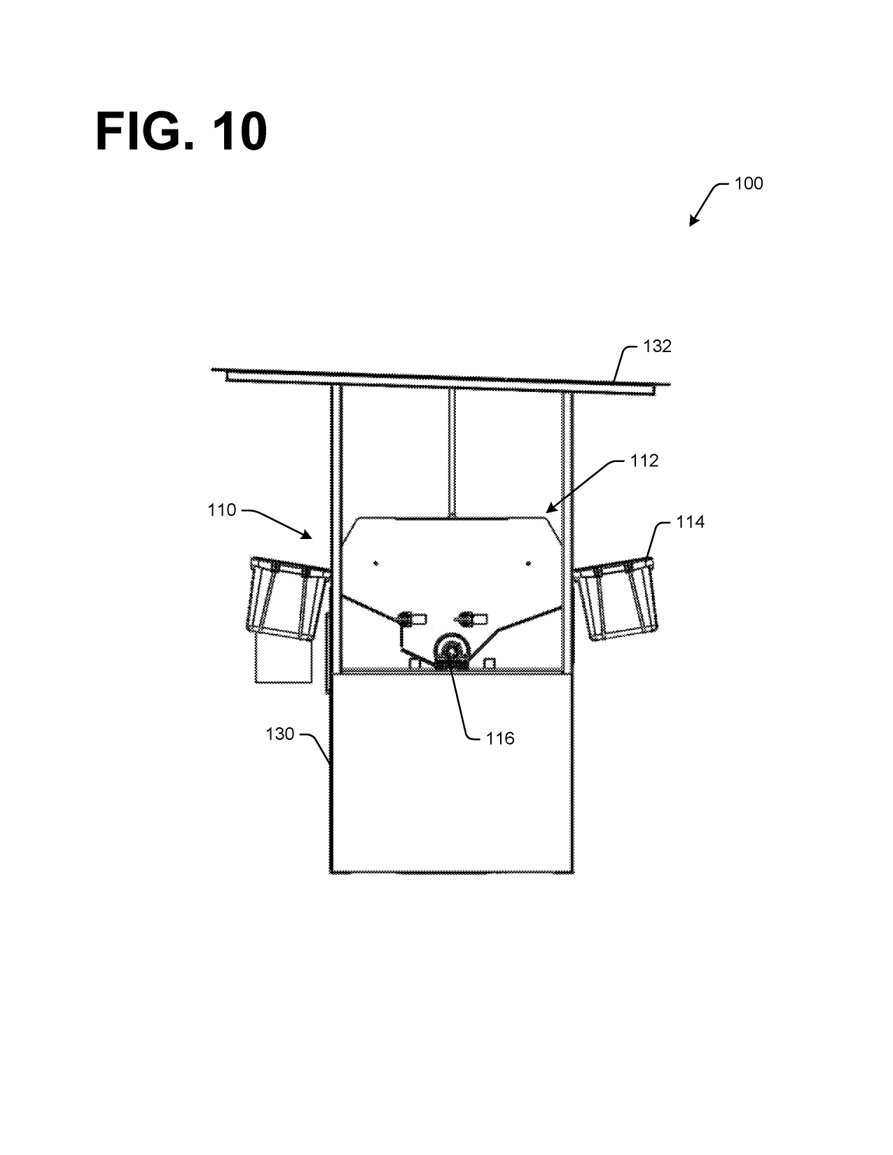

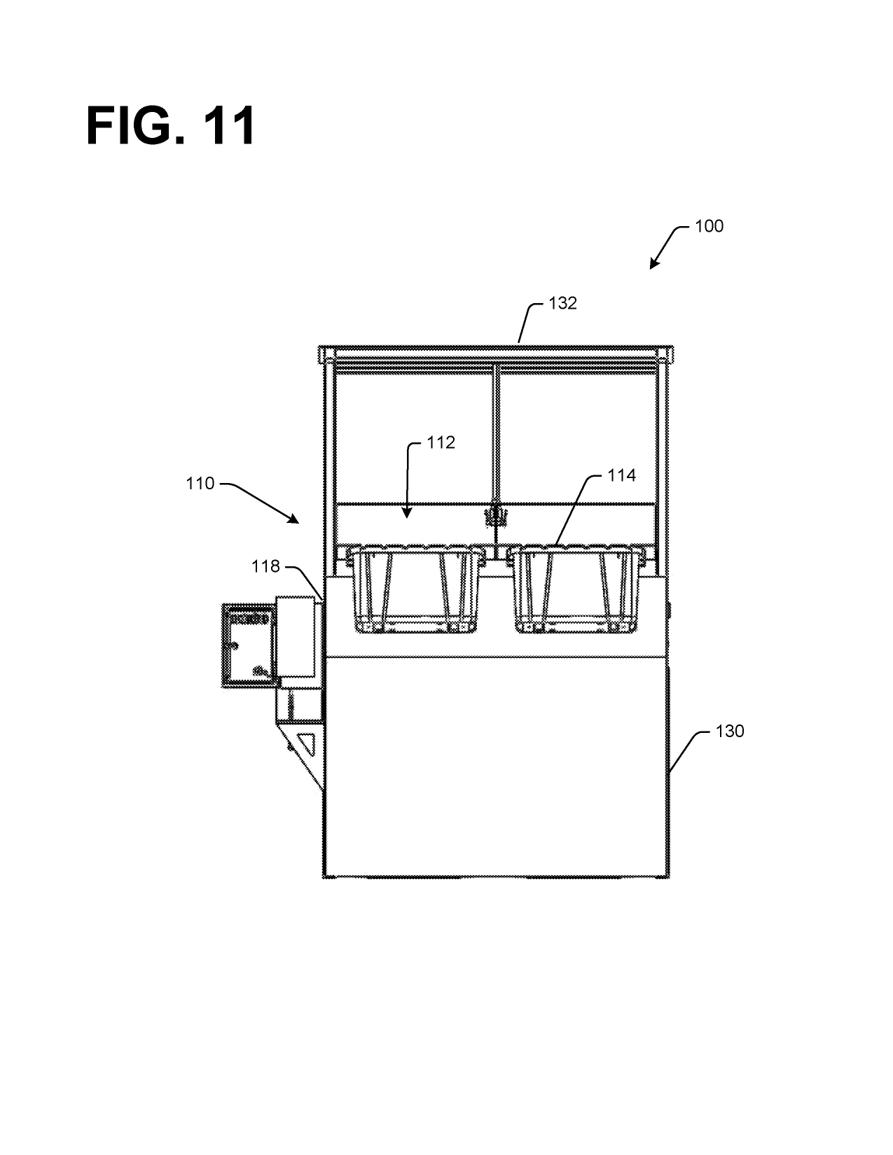

FIGS. 4-7 are various isometric views of an example apparatus 100 for implementing the example recyclables processing system and method. FIGS. 8-11 are various side views of the example apparatus 100 depicted in FIGS. 4-7. An example of the apparatus 100 for the example recyclables processing system and method is configured for reducing the volume, and hence increasing densification of recyclable plastic containers.

In an example, the apparatus 100 includes a hopper 110, which has one or more loading openings. The loading openings are configured to receive the recyclable plastic containers into the hopper (e.g., from collection buckets 114). A shaft 116 extends at least partly through the hopper 110. A drive motor118 is operatively coupled to the shaft 116. The drive motor 118 is configured to rotate the shaft 116 about a central axis of the shaft 116. The drive motor 118 may be an electric motor or a hydraulic motor, and the operative coupling may include a gear reduction assembly to provide high-torque, low-speed rotation, which minimizes noise and energy consumption.

A plurality of tines or blades 120 are mounted to the shaft 116. These tines or blades 120 are configured so as to rotate with the shaft 116 about the central axis. In various example systems, these elements may be configured as stiff tines, sharp-edged blades, or crushing bars, and they may be welded to the shaft or be replaceable elements bolted onto the shaft 116.

The processing action of the apparatus 100 is defined by the interaction of the rotating elements and fixed slots. The hopper 110 may include one or more plates 122 which define a plurality of slots 124. During operation, the tines or blades 120 rotate through the plurality of slots 124 provided at the bottom of the hopper 110, which enables the tines or blades 120 to enter an interior portion of the hopper 110. In this position, they contact the recyclable plastic containers loaded therein.

In an example, there is provided a plate 122 on each side of the shaft 116, each defining a second plurality of slots 124. As the shaft 116 rotates, the tines or blades 120 rotate into the slots 124 on one side of the shaft 116, and out of the slots 124 on the opposite side of the shaft 116 to exit the interior portion of the hopper 110. This configuration enables the removal of material that may become wrapped around the shaft 116 and/or tines or blades 120.

The rotation of the tines or blades 120 through the hopper 110 is configured to pierce and compact the recyclable plastic containers in the hopper 110. This action expels air and residual liquids from the plastic containers. The pierced and compacted recyclable plastic containers are subsequently released from the hopper 110 through an exit opening 126 located in a lower portion of the hopper 110. A collection container 128 is positioned to receive the pierced and densified portions of the shredded recyclable plastic containers as they are released.

In an example apparatus 100, a housing 130 supports the hopper 110. This housing 130 defines a space beneath the exit opening, and this space is configured to receive the collection container 128. The housing 130 elevates the hopper 110 to a height sufficient to enable the collection container 128, which may be configured as a material handling cart, to be rolled into and out of the space beneath the exit opening 126. This simplifies the removal of the processed material.

In an example, the hopper 110 is substantially v-shaped. This v-shape is configured to direct the shredded recyclable plastic containers downward toward the shaft 116 and the processing elements 120, thereby promoting efficient feeding into the shredding mechanism. The apparatus 100 may also include a cover 132. The cover 132 is configured to selectively enclose the loading opening 112, which serves to prevent rain and debris from entering the hopper 110, particularly when the apparatus 100 is installed in an outdoor or semi-exposed location.

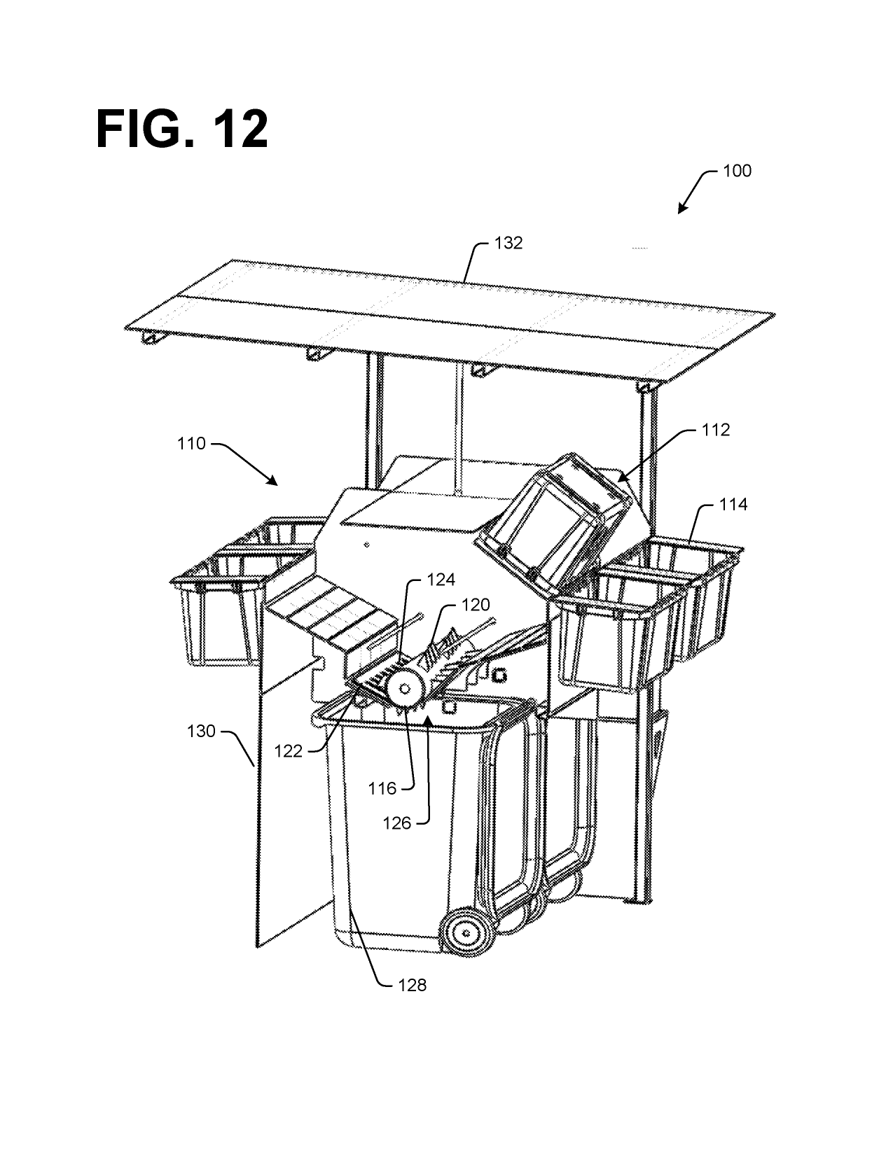

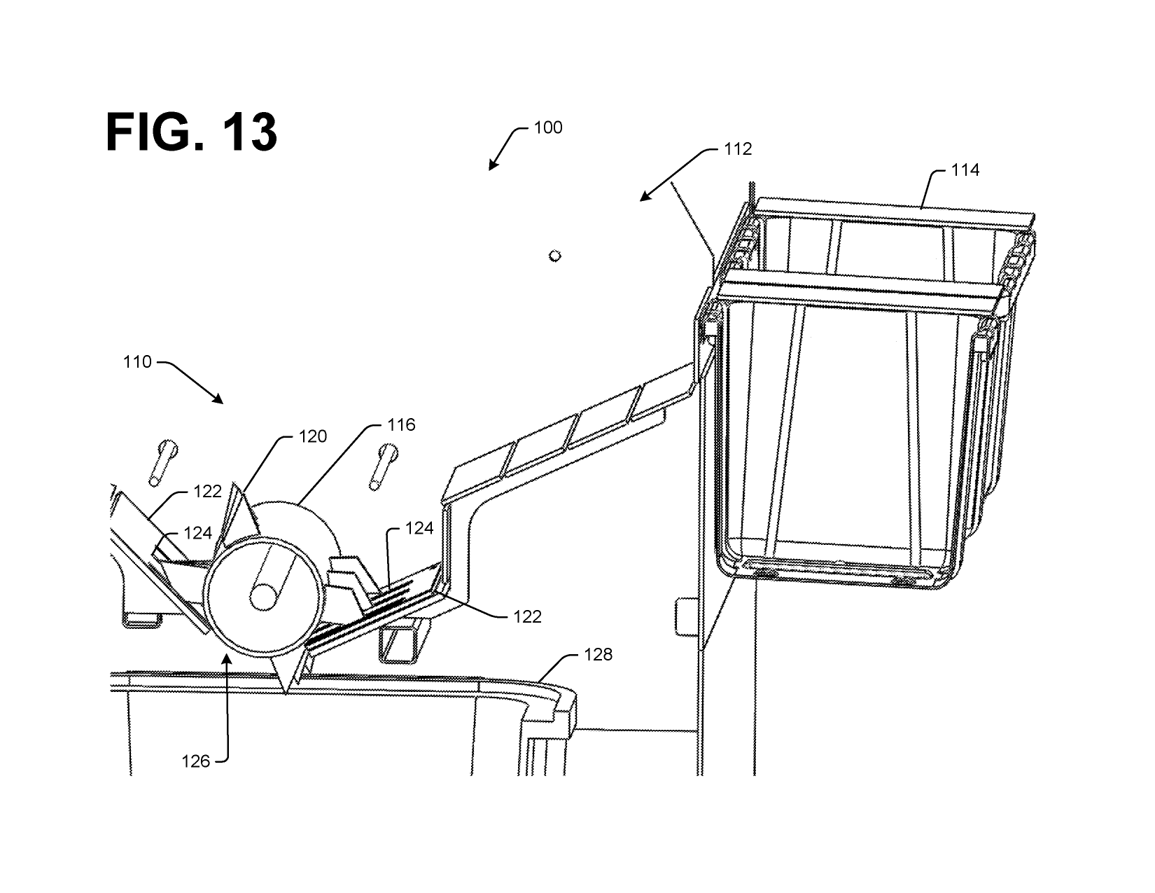

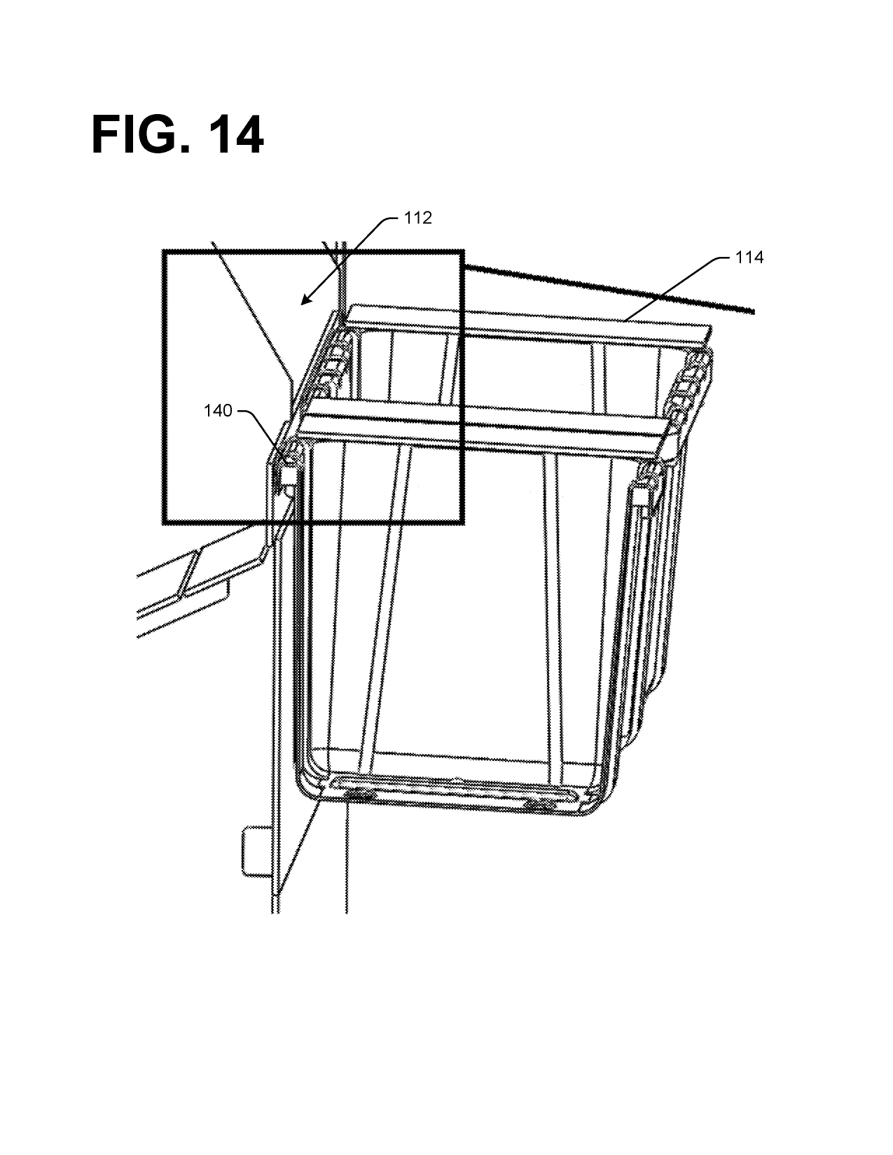

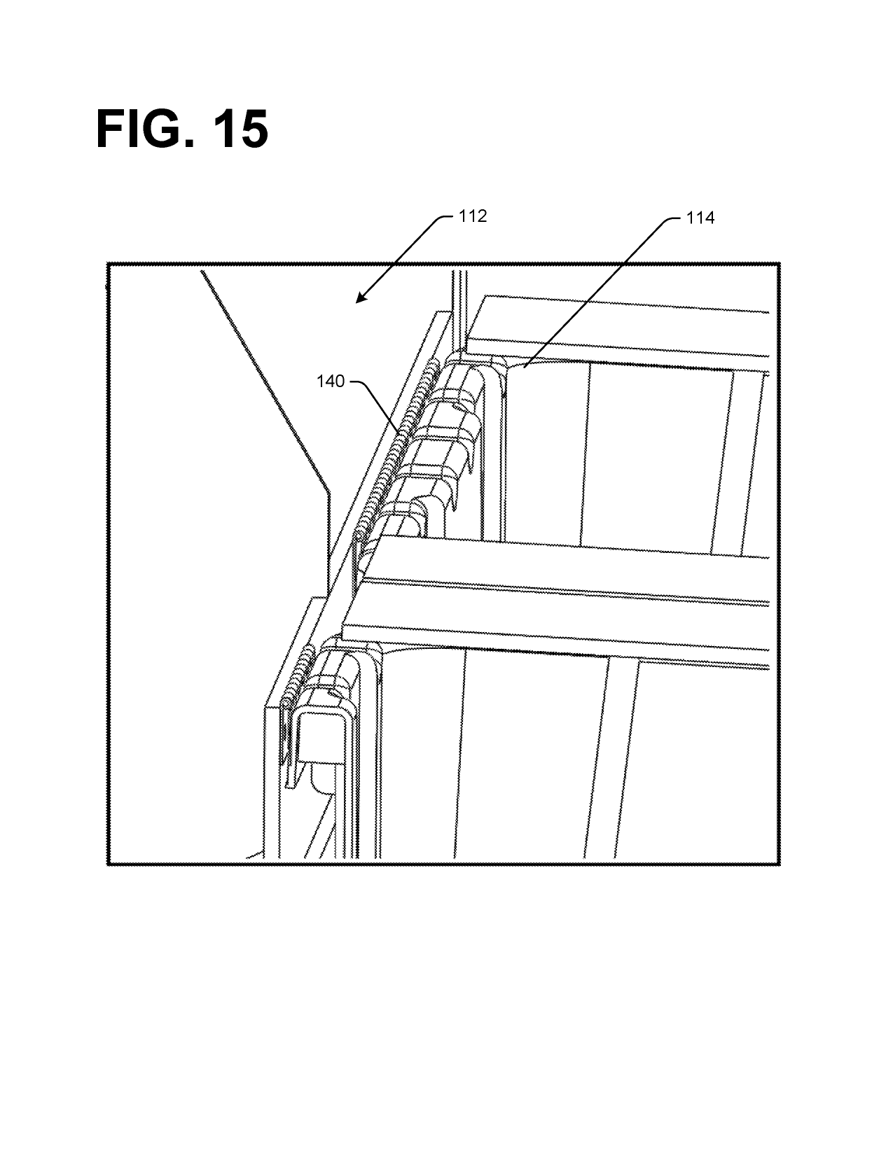

FIGS. 12-15 are close-up isometric views showing an example infeed hopper assembly of the example apparatus depicted in FIGS. 4-7. As noted above to facilitate user loading, the apparatus 100 may include one or more infeed buckets 114. The infeed buckets 114 are positioned adjacent to the loading openings 112, providing convenient access. Each infeed bucket 114 is hingedly attached to the apparatus 100, such as to the hopper 110, adjacent to the loading opening 112. Each infeed bucket 114 is configured to be rotated by a user on a hinge 140 (as illustrated in FIG. 12). This rotation moves the bucket 114 from a receiving position, in which the user deposits the recyclable plastic containers into the bucket 114, to an unloading position. In the unloading position, the bucket 114 inverts and empties its contents, the recyclable plastic containers, into the loading opening 112 of the hopper 110.

The apparatus 100 may be configured for on-demand, automatic operation to conserve energy. In one example system, an actuation switch is operatively coupled to the hinge 140 of at least one of the infeed buckets 114. This actuation switch is configured to automatically activate the drive motor 118 when the infeed bucket 114 is rotated to the unloading position. In another example, a material sensor can be positioned within the hopper 110. The material sensor, which may be an optical, weight, or proximity sensor, is operatively coupled to the drive motor 118. The material sensor is configured to detect the presence of the recyclable plastic containers within the hopper and to automatically activate the drive motor 118 upon said detection.

In operation, recyclable materials, such as plastic containers, are loaded into the hopper 110. The motor 118 rotates the shaft 112, causing the shredding elements 120 to engage the containers. The high-torque, low-speed action pulls the material downward toward the bottom plate. The shredding elements 120 pierce, shred, and crush the materials, forcibly expelling trapped air and residual liquids. This action forces the now-compacted and volume-reduced material through the fixed openings 124 at the bottom of the hopper 110. The processed material then falls directly into the collection container or cart 128 positioned beneath the assembly.

Alternative configurations are consistent with this example system. For example, the shredding elements 120 themselves may take various forms, including hooked tines to more aggressively pull material, flat bars for a crushing action, sharp-edged blades for shearing, or toothed gears. These elements may be arranged on the shaft in a specific pattern, such as a spiral or helix, to distribute the load on the motor and provide a continuous processing action. In another example, the assembly may include two or more parallel shafts. These shafts may be configured to be counter-rotating, with their respective shredding elements interleaving or meshing to provide a more aggressive shredding and pulling action.

The configuration of the fixed bottom plate(s) 122 may also vary. The openings 124 may comprise a plurality of parallel slots, a grate pattern, or a single large opening with a corresponding shear bar. The relationship between the rotating elements 120 and the fixed openings 124 creates the shearing and densification. The tines or blades 120 may pass directly through the slots 124, or they may pass with a tight tolerance against the fixed edges of the slots 124. A fixed scraper bar, or a comb-like structure, may also be integrated near the return path of the rotation. This component serves as a return opening, stripping any material that may get wrapped around the shaft or the tines and ensuring continuous, non-clogging operation.

The apparatus 100 is specifically configured to enable the new, decentralized recyclables handling process by addressing the problems of the prior art. The entire assembly is compact, enabling the example recyclables processing system and method to be scaled to a small footprint. This small size, along with clean, quiet and efficient operation, enables implementation at nonconventional "neighborhood" locations, such as grocery stores, apartment complexes, or convenience centers, where space is limited and large industrial equipment is not feasible.

The operational characteristics are also configured for these sensitive locations. The use of a high-torque, low-speed rotational action generates minimal noise and vibration. This quiet operation contrasts starkly with the high-decibel noise of conventional high-speed shredders or impact-based compactors, making the example apparatus suitable for use near businesses and residential neighborhoods. Furthermore, the action is enclosed within the hopper 110, and the processed material drops directly into a collection cart, which minimizes the creation of airborne dust or the aerosolization of residual liquids.

Finally, the energy consumption is substantially lower than prior art systems. The low-speed motor requires significantly less power than large-scale industrial machinery. The apparatus 100 is configured for intermittent, on-demand use. The drive motor 118 may be activated only when the contents of a bin are dumped into the hopper, potentially triggered by a sensor, a manual push-button, or a key switch. This contrasts with the continuous energy consumption of large MRF sorting lines, making the example apparatus 100 an economical and efficient solution that enables the disclosed process improvements.

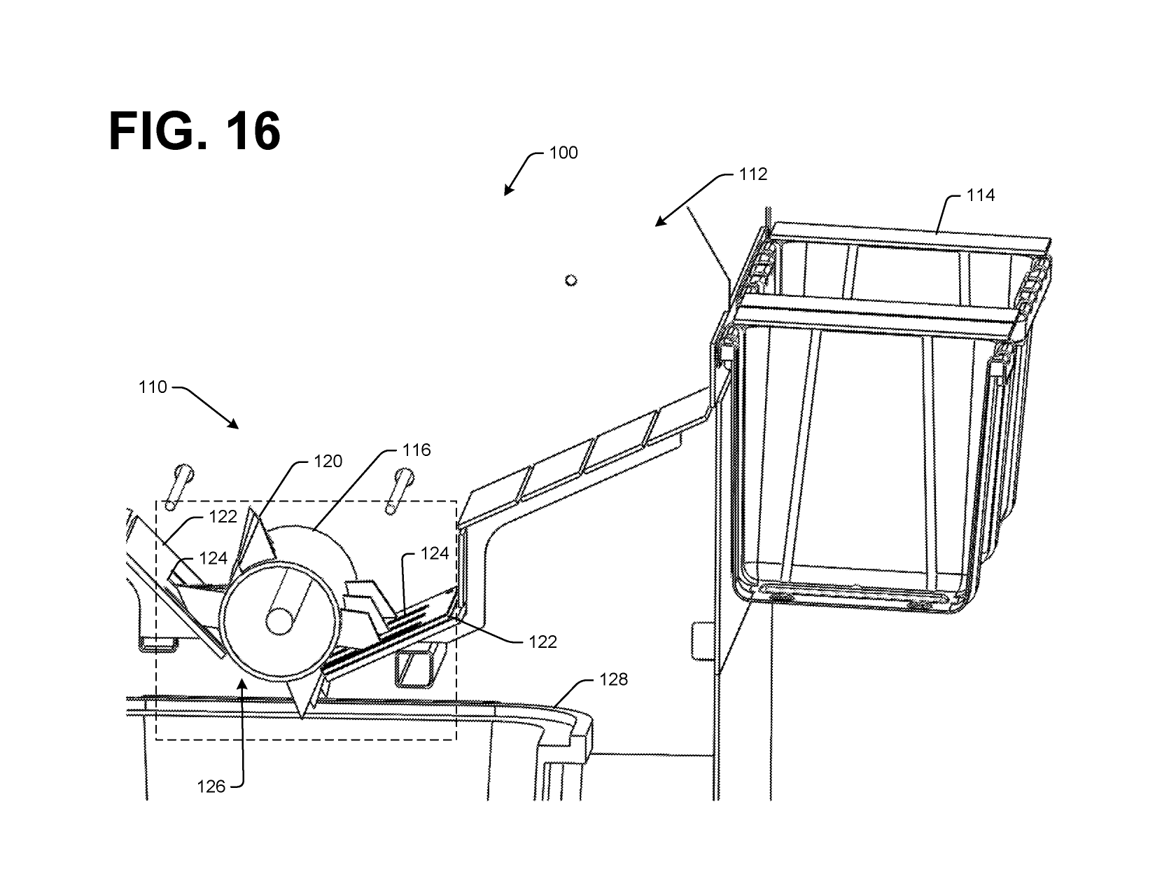

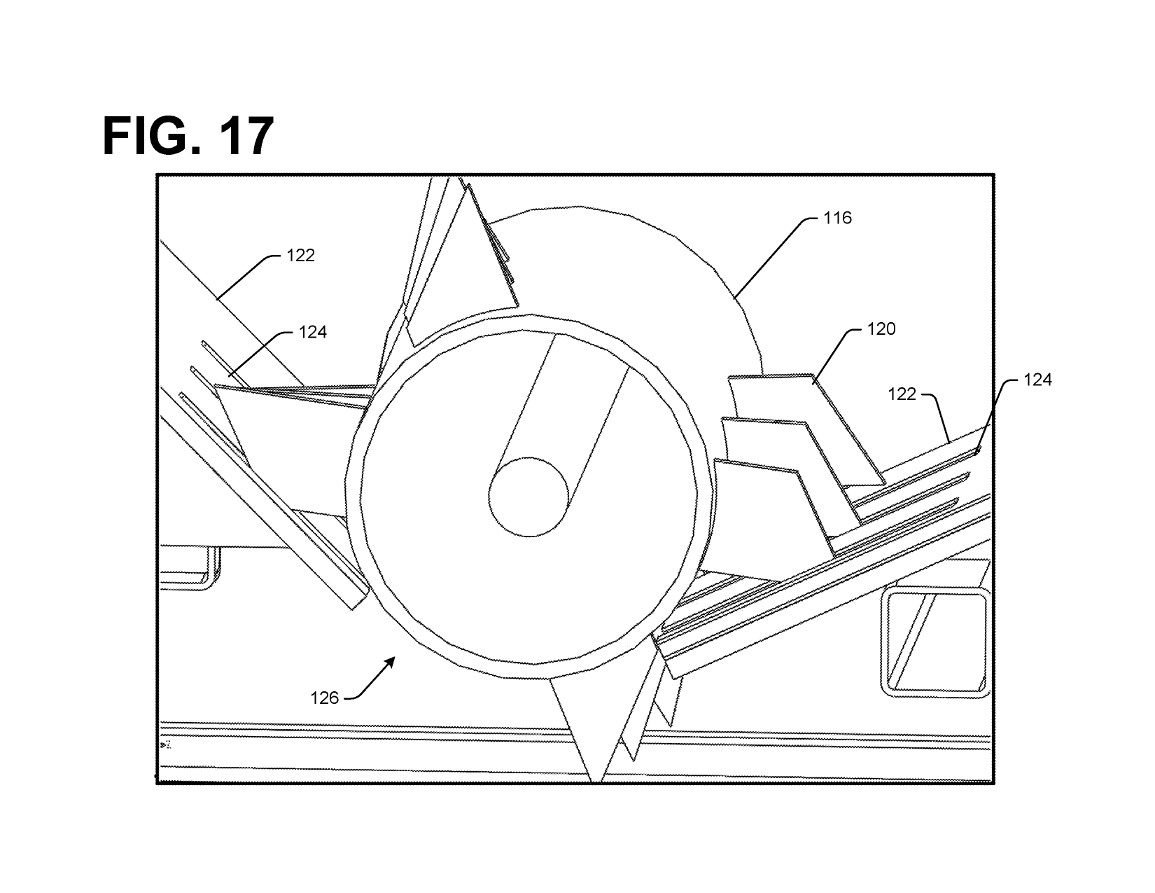

FIGS. 16-17 are close-up isometric views showing an example rotary shredding assembly of the apparatus depicted in FIGS. 4-7. The example apparatus 100 is configured for reducing volume and increasing densification of recyclable plastic containers. As described above, a shaft 116 extends at least partly through the hopper 110 and is rotated by a drive motor 118 for rotating the shaft 116 about its central axis. A plurality of tines or blades 120 are mounted to rotate with about the central axis of the shaft 116 as the shaft 116 is rotated by the drive motor 118.

A plurality of slots 124 are provided in the hopper 110 (e.g., on a first side of the hopper). The slots 124 may be provided at or near the bottom of the hopper 110, for gravity feeding the plastics into the hopper 110, and releasing the pierced and shredded plastics out of the hopper 110. The tines or blades 120 rotate through the plurality of slots 124 coming into the hopper 110 and contact the recyclable plastic containers in the hopper 110.

During operation, the tines or blades 120 rotate through the slots 124 to exit the hopper 110 as the shaft 116 continues to rotate. The tines or blades 120 come into contact with and pierce and thus shred the recyclable plastic containers in the hopper 110. The pierced and shredded recyclable plastic containers are released from the hopper 110 through an exit opening 126 in the hopper 110 and enter into a collection container 128 in a highly densified form.

The pierced and shredded recyclable plastic containers can be released on an ongoing basis from the hopper 110 through an exit opening 126 in the hopper 110. After exiting the hopper 110, the pierced and compacted plastic enters into a collection area, such as a container 128, bin, or other suitable means for collecting and the pierced and densified plastics. The collected plastics may be transported in the containers 128 to a collection vehicle for transport to a plastics recycling facility. The collection vehicle can be a much smaller vehicle than would otherwise be required to move large bales of plastics.

It is noted that still other examples of apparatus 100 are contemplated as being within the scope of this disclosure. In an example, the apparatus 100 may include a trap adjacent to the hopper. The trap retains the recyclable plastic containers on one side of the hopper and keeps the plastic containers from bouncing around in the hopper to help ensure better piercing and compacting of the recyclable plastic containers. By way of further example, multiple shafts and/or drums (more than two) may be provided within a single hopper.

The apparatus 100 may implement different sizes and/or shapes of shafts, drums, tines, blades, gears and/or spacings. The shafts, drums, tines, blades, gears and/or spacings may be positioned in any suitable orientation within the hopper. For example, a first drum can be mounted to a first shaft and the tines are mounted to the first drum. A second drum can be mounted to a second shaft, and the plurality of slots are provided in the second drum.

By way of further illustration, a first plurality of spaced apart gears are mounted to rotate with the first shaft about the central axis of the first shaft. A second plurality of spaced apart gears are mounted to rotate with the second shaft about the central axis of the second shaft. The first plurality of spaced apart gears rotate between the second plurality of spaced apart gears, and the second plurality of spaced apart gears rotate between the first plurality of spaced apart gears slots. As such, the first plurality of spaced apart gears and the second plurality of spaced apart gears contact the recyclable plastic containers between the rotating gears.

In an example, the first plurality of gears may align with the second plurality of gears, as shown in the photos, and the plastics are pierced and compacted between the counter-rotating gear sets. In another example, the first plurality of gears may align with the spaces formed between the second plurality of gears (not shown), enabling the first and second set of gears to be positioned closer to one another, overlapping one another, to rotate into the spaces formed between the gears on the opposing shaft.

The counter-rotating gears pierce and compact the recyclable plastic containers therebetween in the hopper. As the piercing and compacting continues, the pierced and compacted recyclable plastic containers are released from the hopper through an exit opening in the hopper and may enter into a collection area, such as a container, bin, or other suitable means for collecting and the pierced and compacted plastics. The collected plastics may be transported in the containers and/or further compacting and/or baled for temporary storage and/or transport to a plastics recycling facility.

These and other variations will be readily appreciated by those having ordinary skill in the art after becoming familiar with the teachings herein, such that the recyclable plastic containers enter into the hopper, are pierced and compacted, and discharged, thereby significantly reducing the overall volume, including air space and liquids, of the plastics, making transportation of the pierced and compacted plastics more efficient than simply transporting the sorted plastics and/or conventional means for compacting plastic containers.

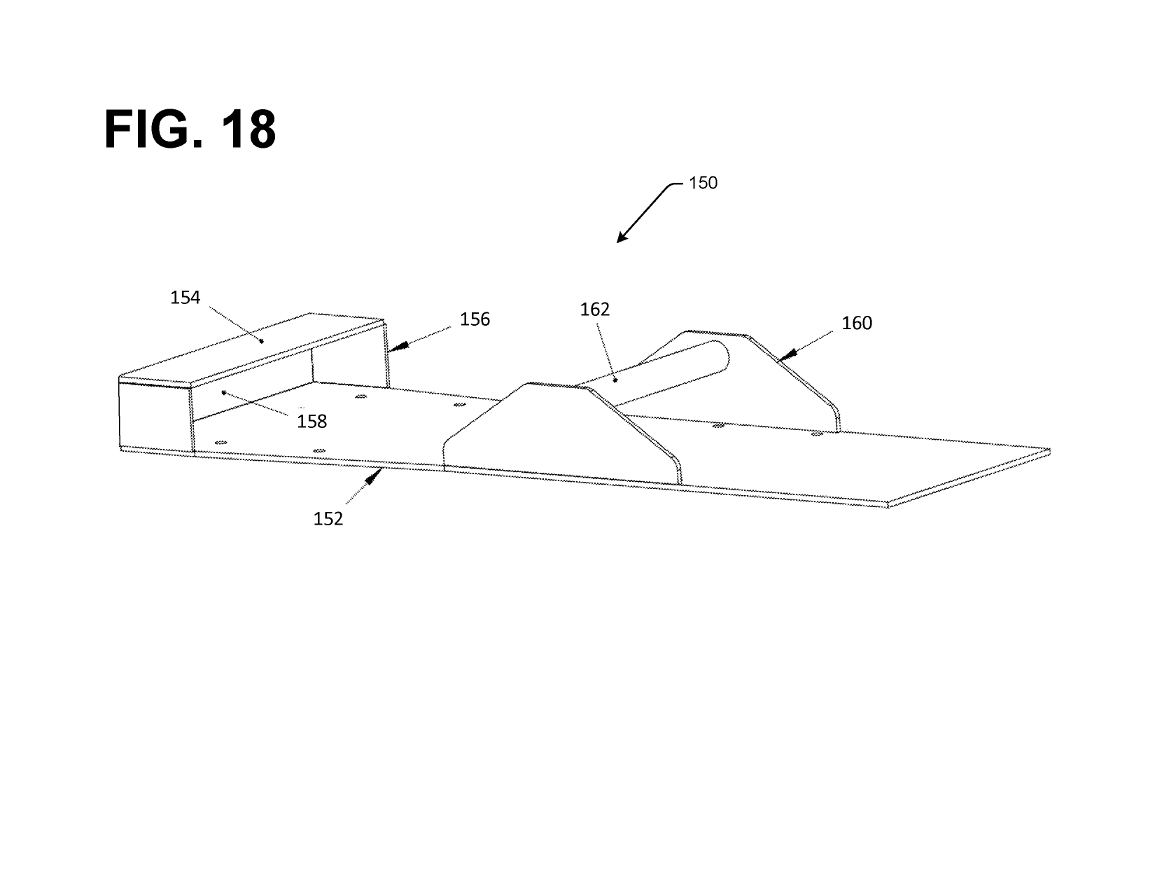

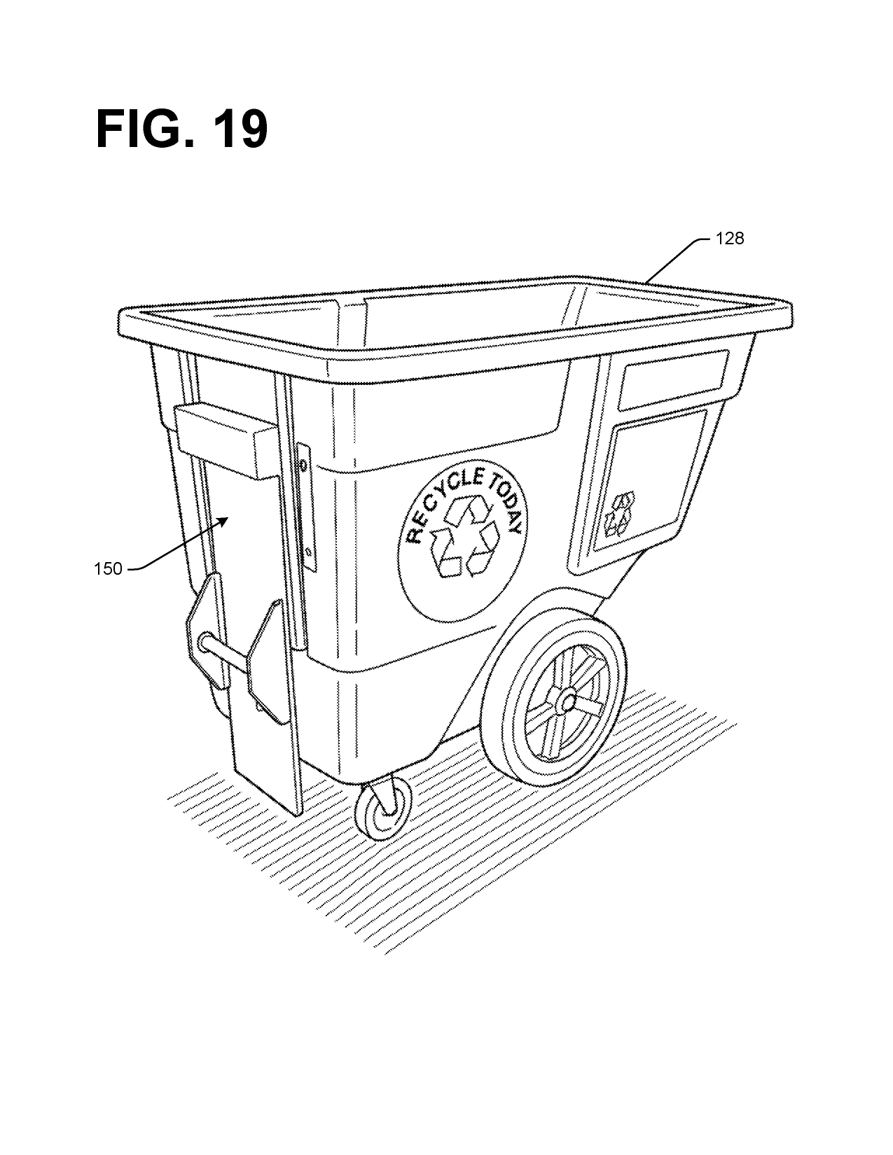

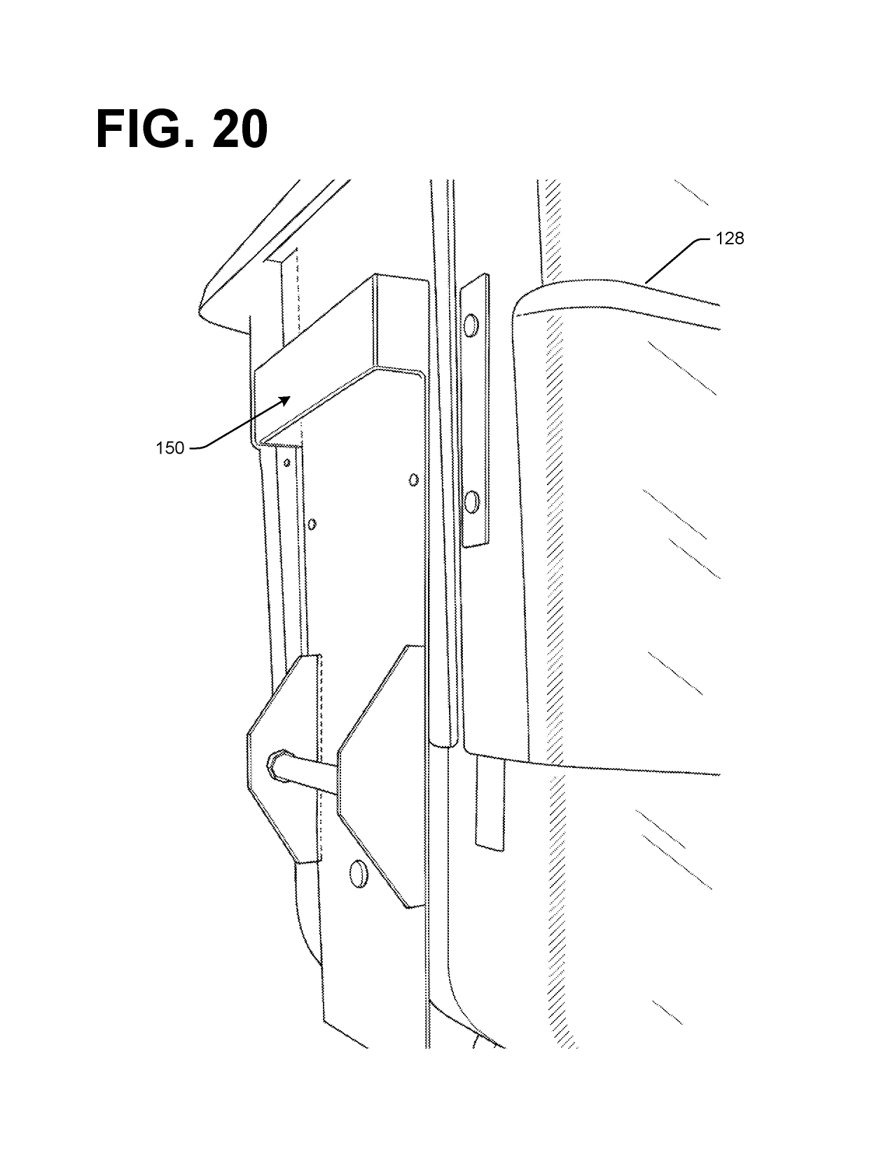

FIG. 18 is an isometric view of an attachable gripping member 150 which can be implemented with the example recyclables processing system and method. FIGS. 19-20 are isometric views showing the attachable gripping member 150 depicted in FIG. 18 as it may be implemented with a bulk material handling cart 128 of the example recyclables processing system and method.

In an example, the attachable gripping member 150 includes a base plate 152 which provides a surface for mounting the member 150 to the cart 128. An upper housing 154 may be formed at one end of the base plate 152, defining a vertical mounting surface 156 and an opening 158. A pair of spaced-apart lifting brackets 160 extend upward from the base plate 152. A gripping bar 162 extends between and is supported by these lifting brackets 160.

FIGS. 19 and 20 are isometric views showing the attachable gripping member 150 as it may be implemented with the bulk material handling cart 128. FIG. 19 shows the gripping member 150 attached to a side wall of the cart 128, and FIG. 20 provides a close-up view of this attachment.

This attachable gripping member 150 enables retrofitting of the movable collection container (the cart) to be integrated with existing automated waste collection vehicles, such as the conventional garbage trucks depicted in FIGS. 2 and 3. After the cart 128 is filled with pierced and densified material from the apparatus 100, an operator can wheel it to a collection vehicle. The gripping bar 162 is configured to be engaged by the grabber arm of the automated truck. This enables the truck's mechanism to securely lift, invert, and empty the contents of the cart 128 into the truck's hopper in the same manner it would handle a conventional household garbage can. This component allows the disclosed system to utilize existing municipal collection fleets without requiring specialized vehicles or lifting equipment.

It is noted that the examples shown and described are provided for purposes of illustration and are not intended to be limiting. Still other examples are also contemplated.

1. A method for processing recyclable plastic containers, the method comprising:
providing a recyclables densification apparatus at a decentralized collection location, wherein the decentralized collection location is a public-access site separate from a centralized material recovery facility and not conventionally equipped for large-scale material processing operations, the recyclables densification apparatus having:
an infeed hopper configured to receive the recyclable plastic containers from a user at the decentralized collection location;
a rotary processing assembly positioned within the hopper, the rotary processing assembly including at least one rotating shaft and a plurality of processing elements extending from the at least one rotating shaft;
a fixed plate located at a lower portion of the hopper, the fixed plate defining at least one opening configured to interact with the plurality of processing elements;
an exit opening configured to release processed portions of the containers; and
a movable collection container positioned beneath the exit opening to receive the processed portions of the containers;
receiving the recyclable plastic containers into the infeed hopper at the decentralized collection location;
actuating the rotary processing assembly to rotate the at least one rotating shaft, thereby causing the plurality of processing elements to engage the containers;
processing the containers within the hopper by piercing and compacting the containers as the processing elements rotate in proximity to the at least one opening, wherein said processing expels air from the containers and forces the pierced and compacted containers through the at least one opening and the exit opening; and
collecting the pierced and compacted containers in the movable collection container at the decentralized collection location, thereby producing a densified bulk material for efficient transport.

2. The method of claim 1, wherein the decentralized collection location is selected from the group consisting of a grocery store, an apartment complex, a condominium complex, a transfer station, and a convenience center.

3. The method of claim 1, wherein the decentralized collection location is an area sensitive to operational noise, and wherein the step of actuating the rotary processing assembly generates minimal noise relative to the area sensitive to operational noise.

4. The method of claim 1, wherein the step of actuating the rotary processing assembly consumes low energy, and wherein the actuating is performed intermittently only when recyclable plastic containers are received in the infeed hopper.

5. The method of claim 4, wherein the step of actuating is initiated by one of a sensor detecting the presence of containers or a manual user control.

6. The method of claim 1, wherein the step of processing the containers comprises rotating the at least one rotating shaft at a low speed and a high torque.

7. The method of claim 1, wherein the step of processing the containers increases the density of the recyclable plastic containers from approximately 1 pound per cubic foot to approximately 4 pounds per cubic foot.

8. The method of claim 1, wherein the rotary processing assembly comprises a single rotating shaft, and wherein the plurality of processing elements are selected from the group consisting of tines, blades, and bars.

9. The method of claim 8, wherein the recyclables densification apparatus further comprises a drum mounted to the single rotating shaft, and wherein the plurality of processing elements are mounted to the drum.

10. The method of claim 8, wherein the fixed plate defines a first plurality of slots, and wherein the step of processing comprises rotating the tines or blades through the first plurality of slots.

11. The method of claim 10, wherein the recyclables densification apparatus further comprises a second plurality of slots configured to clear material from the processing elements during rotation of the processing elements.

12. The method of claim 1, wherein the recyclables densification apparatus further comprises a trap adjacent to the infeed hopper, the trap configured to retain the recyclable plastic containers on one side of the hopper during the processing step.

13. The method of claim 1, further comprising:
transporting the movable collection container away from the recyclables densification apparatus; and
transferring the densified bulk material from the movable collection container into a transport vehicle.

14. The method of claim 1, further comprising attaching a gripping member to configure the movable collection container for handling with existing automated waste collection vehicles.

15. A densification apparatus for reducing the volume of recyclable plastic containers, the apparatus comprising:
a hopper having a loading opening configured to receive the recyclable plastic containers into the hopper;
a shaft extending at least partly through the hopper;
a drive motor operatively coupled to the shaft and configured to rotate the shaft about a central axis of the shaft;
a plurality of tines or blades mounted to the shaft so as to rotate with the shaft about the central axis;
a plurality of slots defined by the hopper, wherein the plurality of tines or blades rotate through the plurality of slots to enter an interior portion of the hopper and contact the recyclable plastic containers therein;
an exit opening in a lower portion of the hopper;
wherein the rotation of the plurality of tines or blades through the hopper is configured to pierce and compact the recyclable plastic containers, and wherein the pierced and compacted recyclable plastic containers are released from the hopper through the exit opening and into a collection container positioned to receive the pierced and compacted recyclable plastic containers.

16. The apparatus of claim 15, further comprising:
a housing supporting the hopper, wherein the housing defines a space beneath the exit opening configured to receive the collection container, and wherein the housing elevates the hopper to enable the collection container, configured as a material handling cart, to be rolled into and out of the space;
wherein the hopper is substantially v-shaped and configured to direct the recyclable plastic containers downward toward the shaft; and
a cover configured to selectively enclose the loading opening to prevent rain and debris from entering the hopper.

17. The apparatus of claim 15, further comprising:
a pair of infeed buckets positioned on opposing sides of the loading opening;
wherein each infeed bucket is hingedly attached adjacent to the loading opening, and wherein each infeed bucket is configured to be rotated by a user on a hinge from a receiving position, in which the recyclable plastic containers are deposited into the infeed bucket, to an unloading position, in which the infeed bucket empties the recyclable plastic containers into the loading opening of the hopper.

18. The apparatus of claim 15, further comprising an actuation switch operatively coupled to the hinge of at least one of the infeed buckets, wherein the actuation switch is configured to automatically activate the drive motor when the at least one infeed bucket is rotated to the unloading position.

19. The apparatus of claim 18, further comprising a material sensor positioned within the hopper and operatively coupled to the drive motor, wherein the material sensor is configured to detect the presence of the recyclable plastic containers and to automatically activate the drive motor upon said detection.
